(19) United States
(12) Patent Application Publication
(10) Pub. No.: US 2026/0176034 A1
(43) Pub. Date: Jun. 25, 2026

(54) SNACK CUP AND LID ASSEMBLY THEREFOR

(71) Applicant: Haier US Appliance Solutions, Inc., Wilmington, DE (US)

(72) Inventors: Min Joo Annie Han, Louisville, KY (US); Alexander Marovec, South Haven, MI (US); Lauren Nicole Platts, Louisville, KY (US)

(21) Appl. No.: 18/990,082

(22) Filed: Dec. 20, 2024

(51) Int. Cl. B65D 51/28; B65D 47/28

(52) U.S. Cl. CPC B65D 51/28; B65D 47/286

(57) ABSTRACT

A snack cup assembly includes a cup defining an interior volume and a lid assembly removably coupled to the cup. The lid assembly includes a filter bucket removably coupled within the interior volume of the cup and an ice bucket positioned atop the filter bucket in the axial direction. The ice bucket including a rim defining a slot. The snack cup assembly also includes a ring positioned atop the rim of the ice bucket in the axial direction. The ring is configured to couple to the filter bucket through the slot in the ice bucket. The snack cup assembly further includes a lid removably coupled to the ring. The lid defines a slot and an opening within the slot. The ice bucket is rotatable between a first position and a second position within the lid assembly.

### FIELD OF THE INVENTION

The present subject matter relates generally to snack cups, and more specifically to lid assemblies for snack cups.

### BACKGROUND OF THE INVENTION

Ice makers generally produce ice for use by consumers, such as in beverages, for cooling food items, etc. Certain refrigerator appliances include ice makers for producing ice. The ice maker can be positioned within the appliance's freezer chamber and direct ice into an ice bucket where the ice is stored within the freezer chamber. Such refrigerator appliances can also include a dispensing system for assisting a user with accessing ice produced by the refrigerator appliance's ice maker. Stand-alone ice makers may be separate from refrigerator appliances and provide independent ice supplies. Generally, liquid water is added to the stand-alone ice makers, and the ice makers operate to freeze the liquid water and form ice.

Stand-alone ice makers may generally be configured to provide nugget ice, otherwise referred to as snack ice. Typically, nugget ice is one general size and shape and is soft textured when compared to the common ice cube. Additionally, nugget ice typically has a melting rate higher than the common ice cube, as well as a lower-density composition. As such, it is typical for users to snack, or chew, on nugget ice. When adding snack ice to beverages, snack ice may melt at a faster rate than the common ice cube, making snacking on the nugget ice in the beverage difficult.

Accordingly, a snack cup configured to hold and dispense nugget ice separate from the beverage may be desirable. In particular, a handheld, portable way to hold and snack on nugget ice along with a beverage may be desirable.

### BRIEF DESCRIPTION OF THE INVENTION

Aspects and advantages of the invention will be set forth in part in the following description, or may be apparent from the description, or may be learned through practice of the invention.

In one example embodiment, a snack cup assembly is provided. The snack cup assembly defines an axial direction, a radial direction, and a circumferential direction. The snack cup assembly includes a cup defining an interior volume and a lid assembly removably coupled to the cup. The lid assembly includes a filter bucket removably coupled within the interior volume of the cup and an ice bucket positioned atop the filter bucket in the axial direction. The ice bucket including a rim defining a slot. The snack cup assembly also includes a ring positioned atop the rim of the ice bucket in the axial direction. The ring is configured to couple to the filter bucket through the slot in the ice bucket. The snack cup assembly further includes a lid removably coupled to the ring. The lid defines a slot and an opening within the slot. A slider is slidably positioned within the slot of the lid. The ice bucket is rotatable between a first position and a second position within the lid assembly.

In another example embodiment, a snack cup assembly is provided. The snack cup assembly defines an axial direction, a radial direction, and a circumferential direction. The snack cup assembly includes a cup defining an interior volume and a lid assembly removably coupled to the cup. The lid assembly includes a filter bucket removably coupled within the interior volume of the cup and an ice bucket positioned atop the filter bucket in the axial direction. The ice bucket including a rim defining a slot. The snack cup assembly also includes a ring positioned atop the rim of the ice bucket in the axial direction. The ring is configured to couple to the filter bucket through the slot in the ice bucket. The snack cup assembly further includes a lid removably coupled to the ring. The lid defines a slot and an opening within the slot. The ice bucket is rotatable between a first position and a second position within the lid assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example snack cup assembly according to aspects of the present disclosure.

FIG. 2 provides a perspective, sectional view of the snack cup assembly of FIG. 1, according to aspects of the present disclosure.

FIG. 3 provides a perspective view of an example snack cup of the snack cup assembly of FIG. 1, according to aspects of the present disclosure.

FIG. 4 provides a perspective view of an example filter bucket of the snack cup assembly of FIG. 1, according to aspects of the present disclosure.

FIG. 5 provides a top view of the filter bucket of FIG. 4, according to aspects of the present disclosure.

FIG. 6 provides a perspective view of an example ice bucket of the snack cup assembly of FIG. 1, according to aspects of the present disclosure.

FIG. 7 provides a top view of the ice bucket of FIG. 6, according to aspects of the present disclosure.

FIG. 8 provides a top view of an example ice bucket coupled to an example filter bucket in a first position, according to aspects of the present disclosure.

FIG. 9 provides a top view of the ice bucket and the filter bucket of FIG. 8, in a second position, according to aspects of the present disclosure.

FIG. 10 provides a perspective view of an example ring of the snack cup assembly of FIG. 1, according to aspects of the present disclosure.

FIG. 11 provides a bottom perspective view of the ring of FIG. 10, according to aspects of the present disclosure.

FIG. 12 provides a top view of the ring of FIG. 10, according to aspects of the present disclosure.

FIG. 13 provides a perspective view of an example lid of the snack cup assembly of FIG. 1, according to aspects of the present disclosure.

FIG. 14 provides a perspective view of an example slider of the snack cup assembly of FIG. 1, according to aspects of the present disclosure.

FIG. 15 provides a bottom view of the slider of FIG. 14, according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. Moreover, the word “example” is used herein to mean “serving as an example, instance, or illustration.” In addition, references to “an embodiment” or “one embodiment” do not necessarily refer to the same embodiment, although it may. Any implementation described herein as “example” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “include(s)” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

As one skilled in the art will appreciate, the below described embodiments are used only for the purpose of explanation. Modifications and variations may be applied, other configurations may be used, and the resulting configurations may remain within the scope of the invention.

Generally, the present disclosure may include a snack cup assembly. The snack cup assembly may include a cup and a lid assembly removably coupled to the cup. The lid assembly may include a filter bucket removably coupled within the cup and an ice bucket positioned atop the filter bucket. The ice bucket may include a rim which defines a slot. The snack cup assembly may also include a ring positioned atop the rim of the ice bucket. The ring may be configured to couple to the filter bucket through the slot in the ice bucket. The snack cup assembly may further include a lid removably coupled to the ring. The lid may define a slot and an opening within the slot. A slider may be slidably positioned within the slot of the lid. The ice bucket may be rotatable between a first position and a second position within the lid assembly.

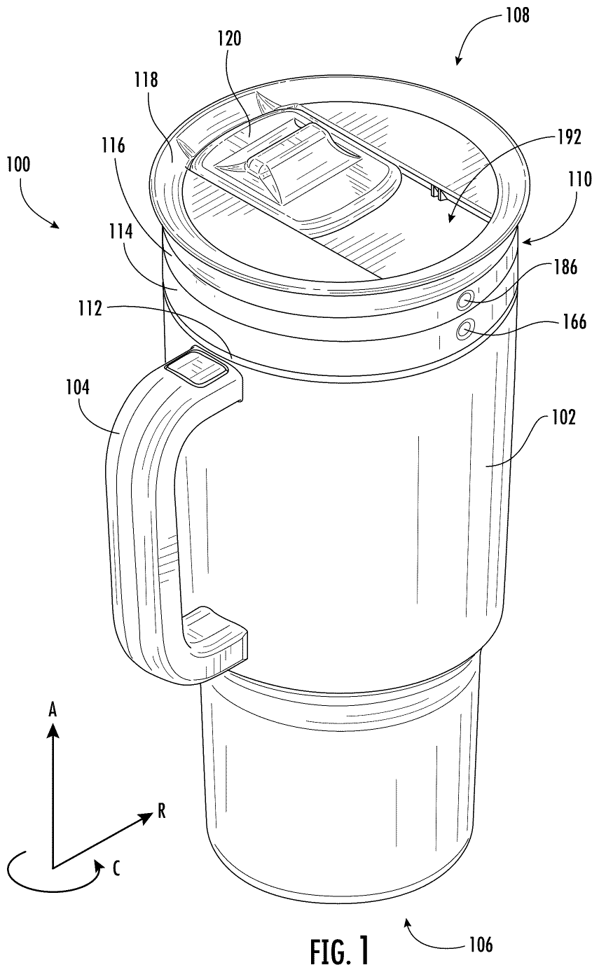

Turning now to the figures, FIG. 1 provides a perspective view of a snack cup assembly 100. In general, snack cup assembly 100 may define an axial direction A, a radial direction R, and a circumferential direction C. In particular, the axial direction A may be perpendicular to the radial direction R, and the circumferential direction C may be a curved or circular direction in a plane defined by the radial direction R, e.g., circumferential direction C may extend around axial direction A. In general, snack cup assembly 100 may include a generally cylindrically shaped cup 102 and a lid assembly 110 coupled to cup 102. In general, cup 102 may extend between a bottom side 106 and a top side 108 in the axial direction A. In some example embodiments, a handle 104 may extend in the radial direction R from cup 102 between bottom side 106 and a top side 108.

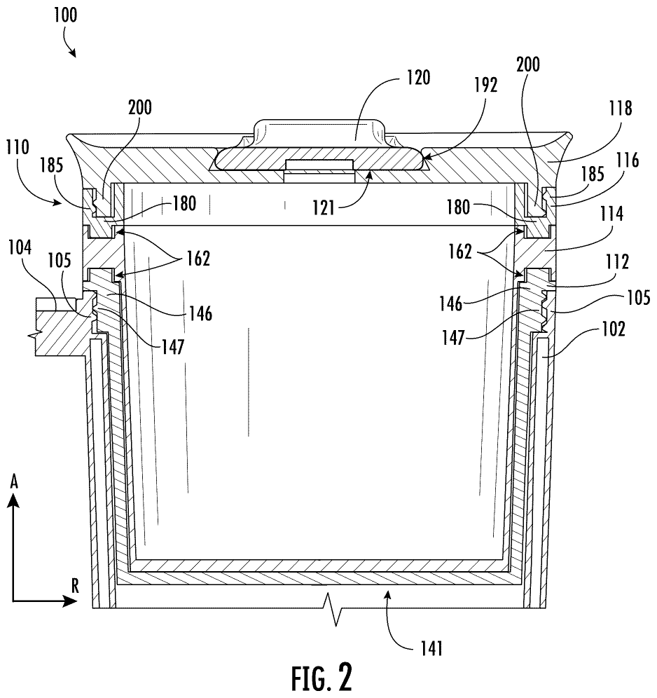

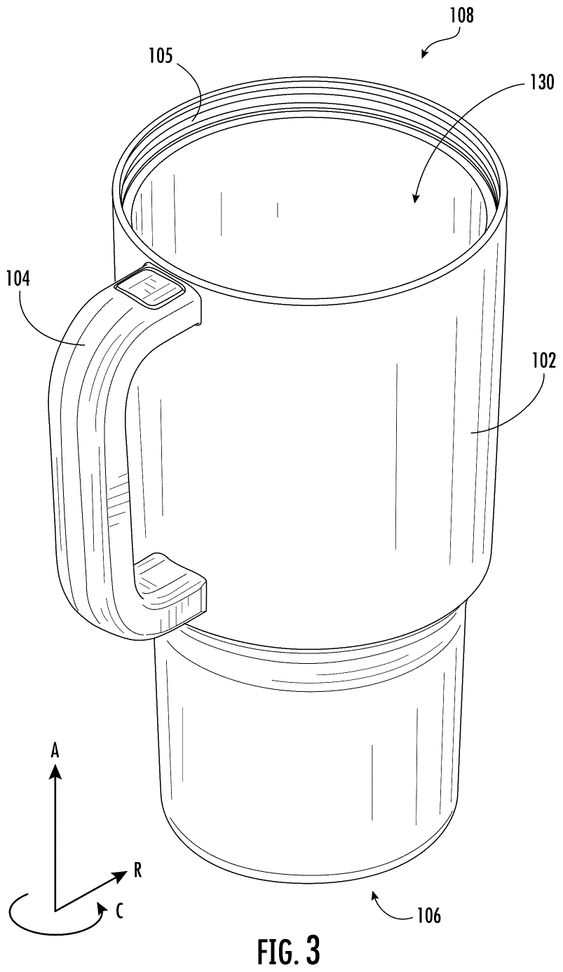

Looking now generally at FIGS. 1 and 2, lid assembly 110 may couple within an interior volume 130 (FIG. 3) of cup 102. Illustrated in FIG. 2 is a side section view of lid assembly 110 within cup 102. In general, lid assembly 110 may be removably coupled to cup 102. Lid assembly 110 may generally include a plurality of components positioned at top side 108 of cup 102. For example, lid assembly 110 may include a filter bucket 112, an ice bucket 114, a ring 116, a lid 118, and a slider 120. In general, filter bucket 112 may couple to cup 102, ice bucket 114 may position, in the axial direction A, atop filter bucket 112, ring 116 may couple to filter bucket 112 through ice bucket 114, lid 118 may couple to ring 116, and slider 120 may position within lid 118. Each of the cup 102, and lid assembly 110 components, e.g., filter bucket 112, ice bucket 114, ring 116, lid 118, and slider 120, will be described in greater detail hereinbelow.

Turning now to FIG. 3, provided is a perspective view of an example cup 102 according to aspects of the present disclosure. As stated above, cup 102 may extend in the axial direction A between bottom side 106 and top side 108. In general, handle 104 may extend in the radial direction R from cup 102 between bottom side 106 and a top side 108. Additionally, cup 102 may define a thread 105 at top side 108, e.g., threads 105 may wrap around the circumferential direction C and face internal volume 130 in the radial direction R within cup 102. As will be explained below, filter bucket 112 may engage/couple to thread 105 when filter bucket 112 of lid assembly 110 is coupled to cup 102. In one example embodiment, cup 102 may be a dual-wall, stainless steel, insulated, tumbler-style cup.

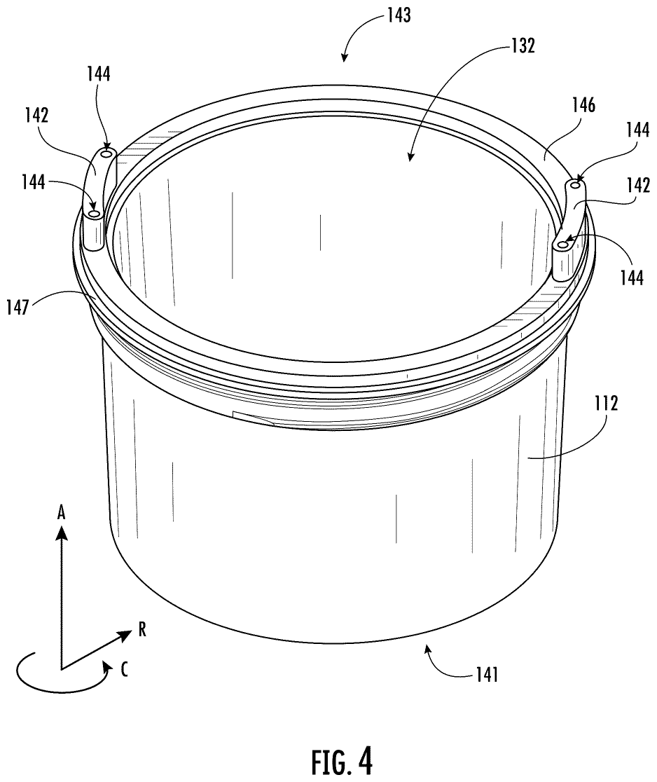

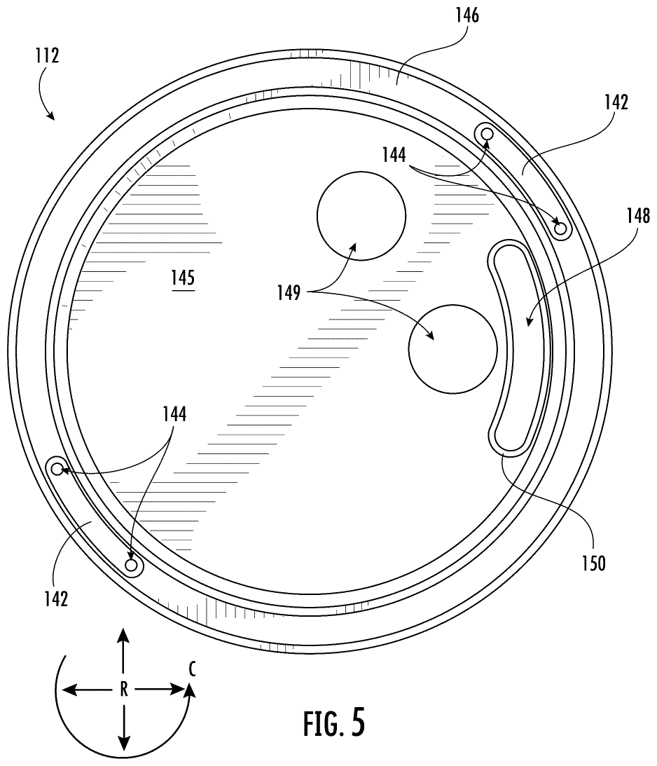

Referring now to FIGS. 4 and 5, provided is an example embodiment of filter bucket 112. In particular, FIG. 4 provides a perspective view of the example embodiment of filter bucket 112 and FIG. 5 provides a top view of the example embodiment of filter bucket 112. In general, filter bucket 112 may be a molded bucket extending in the axial direction A from a bottom side 141 of filter bucket 112 to a top side 143 of filter bucket 112, defining an internal volume 132 between bottom side 141 and top side 143. In particular, filter bucket 112 may include a floor 145 at bottom side 141 of filter bucket 112 and a rim 146 at top side 143 of filter bucket 112, where internal volume 132 may be defined between bottom side 141 and top side 143. In general, filter bucket 112 may define a thread 147 wrapping around the circumferential direction C extending in the radial direction R from filter bucket 112, e.g., thread 147 may face outward from internal volume 132. As such, thread 147 of filter bucket 112 may engage/couple to thread 105 of cup 102 when filter bucket 112 of lid assembly 110 is installed into cup 102. In other words, filter bucket 112 may be removably coupled within interior volume 130 of cup 102.

In general, filter bucket 112 may include a tab 142 extending upwards in the axial direction A from rim 146. Particularly, filter bucket 112 may include two (2) tabs 142 spaced one hundred and eighty degrees (180°) apart around rim 146 in the circumferential direction C. In general, tab 142 may have a plurality of holes 144 extending downward through tab 142. Tab 142 and the plurality of holes 144 will be described in further detail below.

As may be seen in FIG. 5, floor 145 of filter bucket 112 may define an opening 148. In some example embodiments, opening 148 may generally be a curved stadium shape e.g., a type of oval, or otherwise jelly-bean shaped. In general, opening 148 may be positioned along a circumference (not labeled) of filter bucket 112. In the present example embodiment, opening 148 may be lined by a sealing ring 150. In general, sealing ring 150 may be a silicone seal positioned around opening 148 of filter bucket 112. Sealing ring 150 may generally be configured to sealingly engage against ice bucket 114, as will be explained in further detail hereinbelow. Additionally or alternatively, some example embodiments of filter bucket 112 may include one or more holes 149 through floor 145. In general, holes 149 may be configured for receipt of a straw (not shown).

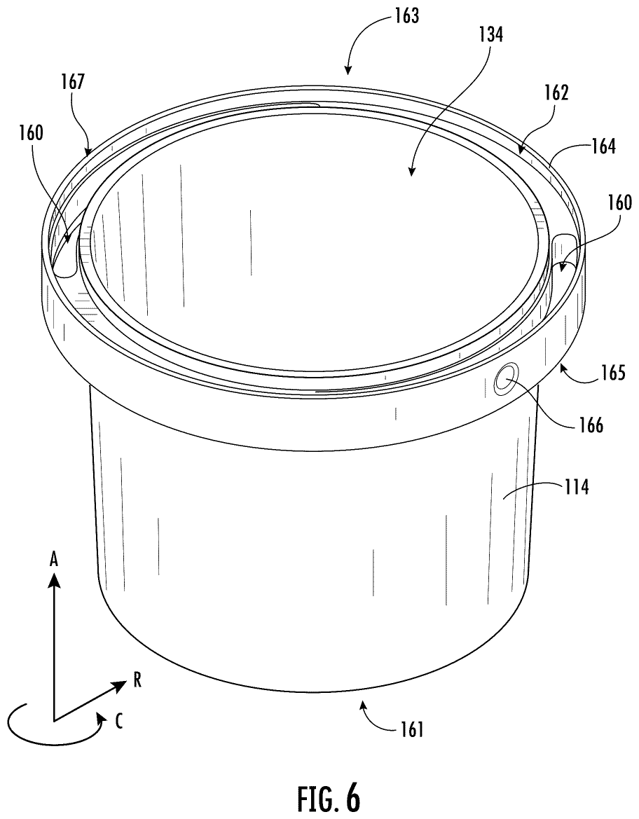

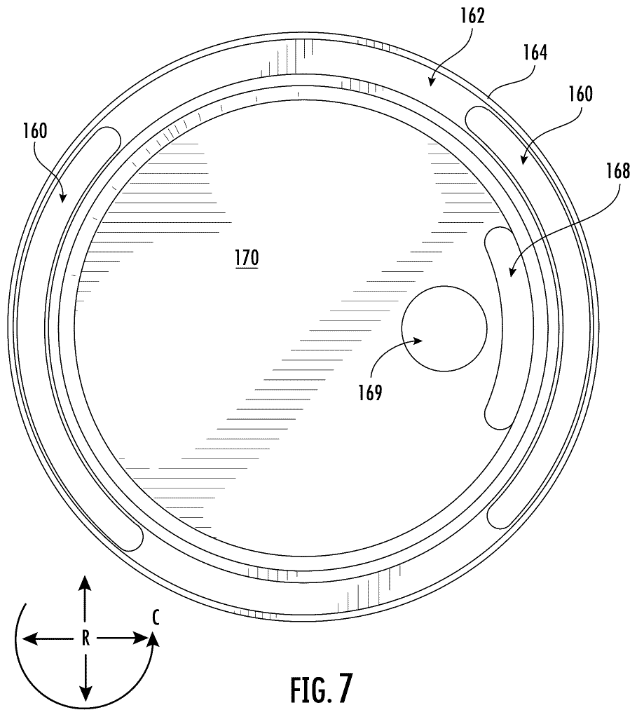

Referring now to FIGS. 6 and 7, provided is an example embodiment of ice bucket 114. In particular, FIG. 6 provides a perspective view of the example embodiment of ice bucket 114 and FIG. 7 provides a top view of the example embodiment of ice bucket 114. In general, ice bucket 114 may be a molded bucket extending in the axial direction A from a bottom side 161 of ice bucket 114 to a top side 163 of ice bucket 114, defining an internal volume 134 between bottom side 161 and top side 163. In particular, ice bucket 114 may include a floor 170 at bottom side 161 of ice bucket 114 and a rim 164 at top side 163 of ice bucket 114, where internal volume 134 may be defined between bottom side 161 and top side 163. In general, ice bucket 114 may define a channel 162 wrapping around the circumferential direction C in a bottom side 165 and a top side 167 of rim 164. In particular, channel 162 in bottom side 165 of rim 164 may position over rim 146 (e.g., at least a portion of rim 146, FIG. 2) of filter bucket 112.

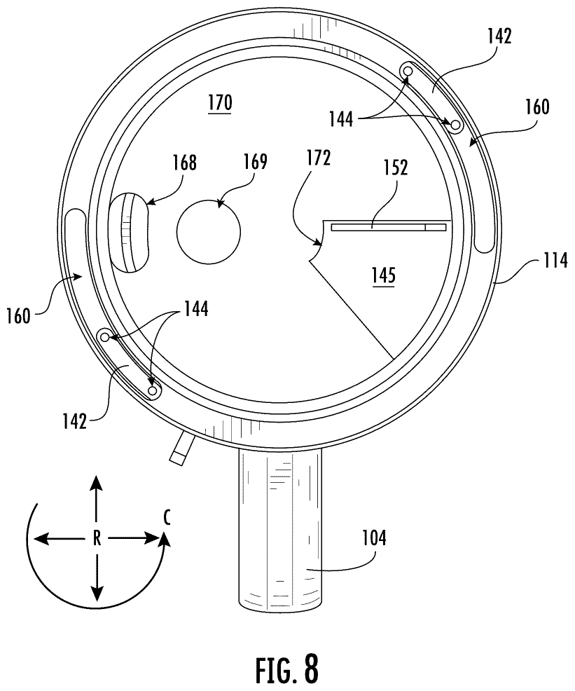

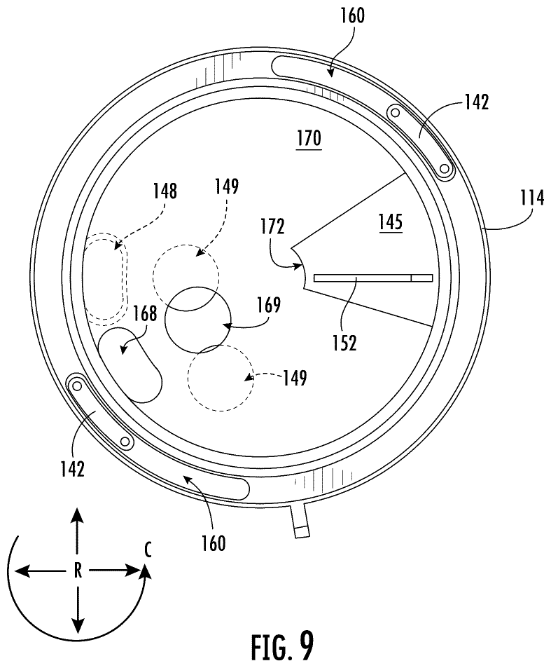

Turning specifically to FIG. 7, channel 162 of ice bucket 114 may generally define a slot 160. In general, slot 160 may generally be a curved stadium shape e.g., a type of oval, along channel 162. In particular, ice bucket 114 may include two (2) slots 160 spaced one hundred and eighty degrees (180°) apart around rim 164 in the circumferential direction C. Slots 160 may be generally configured to receive tabs 142 of filter bucket 112, such that ice bucket 114 may rotate in the circumferential direction C between a first position (FIG. 8) and a second position (FIG. 9) over filter bucket 112. The first position and the second position of ice bucket 114 will be described further herein. In general, rim 164 of ice bucket 114 may include a magnet 166 configured to securely position ice bucket 114 in each the first position and the second position, as will be described in greater detail below.

As seen in FIG. 7, floor 170 of ice bucket 114 may define an opening 168. In some example embodiments, opening 168 may generally be a curved stadium shape e.g., a type of oval, or otherwise complementarily shaped to opening 148 of filter bucket 112. In general, opening 168 may be positioned along a circumference (not labeled) of ice bucket 114. Additionally or alternatively, some example embodiments of ice bucket 114 may include a hole 169 through floor 170. In general, hole 169 may be configured for receipt of a straw (not shown). The positioning of hole 169 will be described further with reference to the first position and the second position of ice bucket 114.

Turning now to FIGS. 8 and 9, provided are top views of an example embodiment of filter bucket 112 and ice bucket 114 assembled in cup 102, where FIG. 8 provides ice bucket 114 in the first position and FIG. 9 provides ice bucket 114 in the second position. Looking specifically at FIG. 8, ice bucket 114 may be shown in the first position, e.g., tab 142 may be positioned at one end (not labeled) of slot 160. For example, the first position of ice bucket 114 may include opening 148 (not labeled) of filter bucket 112 aligning, in the axial direction A, with opening 168 of ice bucket 114. In general, transitioning, or rotating, ice bucket 114 from the first position to the second position may include slot 160 of ice bucket 114 rotating around tab 142 of filter bucket 112, e.g., tab 142 and/or filter bucket 112 may be stationary and ice bucket 114 may rotate independently from filter bucket 112 an/or tab 142. For example, ice bucket 114 may be configured to rotate approximately one hundred degrees (100°) in the circumferential direction C. Looking specifically at FIG. 9, ice bucket 114 may be shown in the second position, e.g., ice bucket 114 may have rotated in the circumferential direction C away from the first position, such that tab 142 is positioned at an other end (not labeled) of slot 160. For example, the second position of ice bucket 114 may include opening 148 of filter bucket 112 offset, in the circumferential direction C, from opening 168 of ice bucket 114. In general, sealing ring 150 around opening 148 may sealingly engage floor 170 of the ice bucket 114, when ice bucket 114 is in the second position. As such, in the second position, liquid within cup 102 may be hindered from flowing through opening 148 by floor 170 of ice bucket 114.

Additionally, as may be seen in FIGS. 8 and 9, filter bucket 112 may include a fin 152 extending upwards in the axial direction A, e.g., as one would understand is out of the page, through a slot 172 in floor 170 of ice bucket 114. In general, fin 152 may be molded with filter bucket 112. In general, slot 172 may be sized to rotate around fin 152 when ice bucket 114 is rotated between the first position and the second position. Fin 152 may generally be configured to engage and break apart ice placed into ice bucket 114, such as ice that has stuck and melted together.

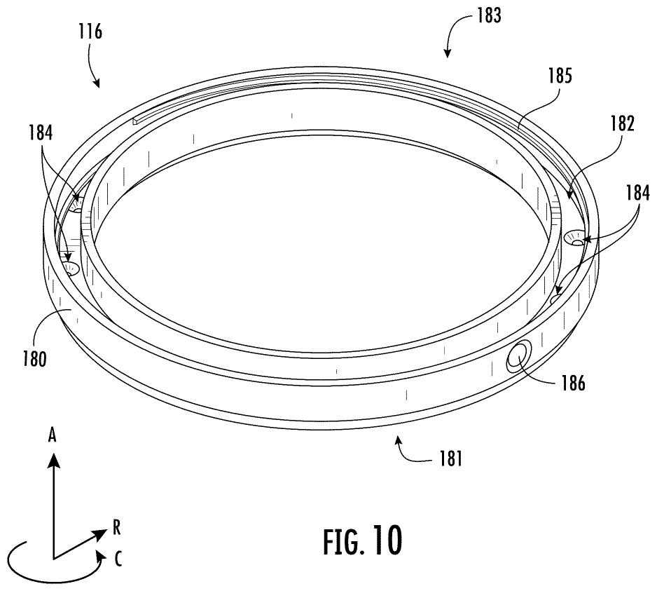

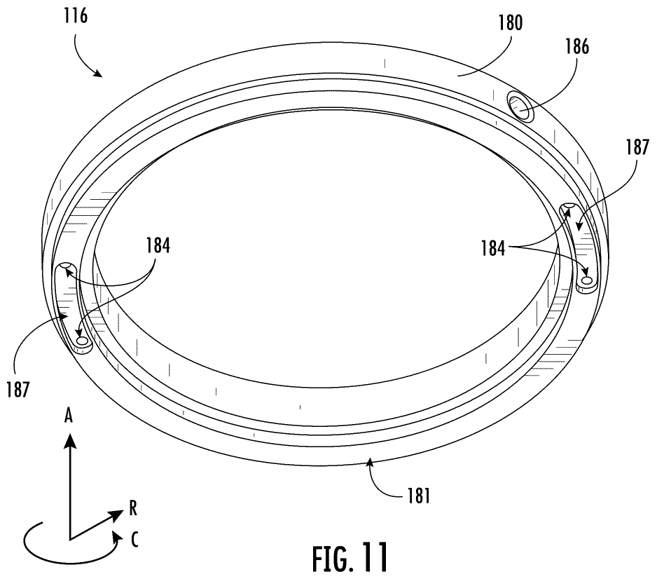

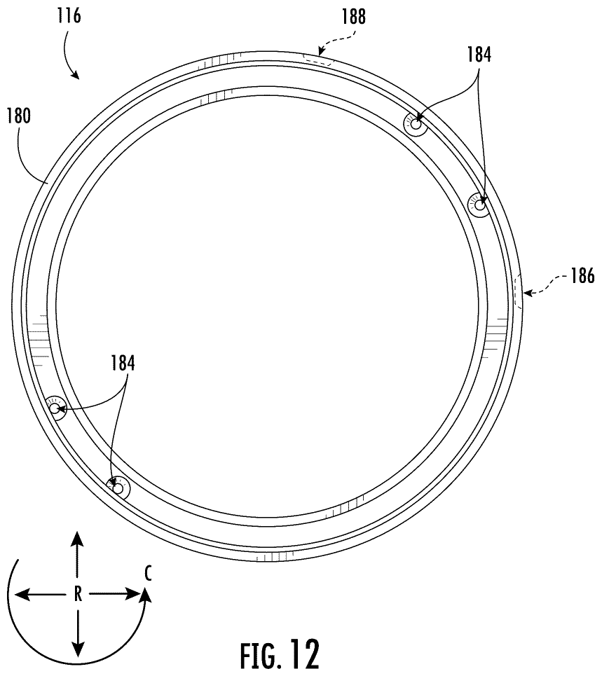

Turning now to FIGS. 10 through 12, provided are various views of an example embodiment of ring 116. In particular, FIG. 10 provides a perspective view of ring 116, FIG. 11 provides a bottom perspective view of ring 116, and FIG. 12 provides a top view of ring 116. In general, ring 116 may include a rim 180 extending around the circumferential direction C. In general, rim 180 may be defined between a bottom side 181 and a top side 183. Ring 116 may generally define a channel 182 in top side 183 of rim 180. In general, ring 116 may be positioned atop rim 164 of ice bucket 114 in the axial direction A. In particular, channel 162 in top side 163 of rim 164 may receive rim 180 of ring 116 (e.g., at least a portion of rim 180, FIG. 2).

In the present example embodiment, channel 182 of ring 116 may define a plurality of holes 184. For example, the plurality of holes 184 may be circumferentially spaced and positioned complimentary to the plurality of holes 144 in tabs 142 of filter bucket 112. As such, fasteners (not shown), such as screws, may be inserted into the plurality of holes 184, through into the plurality of holes 144, thus coupling ring 116 to filter bucket 112 through slot 160 of ice bucket 114. In other words, the plurality of holes 144 of filter bucket 112 and the plurality of holes 184 of ring 116 may be threaded holes configured to receive complimentary threaded fasteners. As such, ice bucket 114 may be rotatable in the circumferential direction C between filter bucket 112 and ring 116. Looking specifically at FIG. 11, some example embodiment of ring 116 may include a slot 187 positioned complimentary to tab 142 of filter bucket 112. In general, slot 187 may be shaped complimentary to tab 142 in order to receive tab 142 when assembling lid assembly 110. Additionally, in some example embodiments, channel 182 of ring 116 may define a thread 185. In general, thread 185 may wrap around the circumferential direction C and extend inwards in the radial direction R, e.g., toward a center (not labeled) of ring 116 within channel 182. In general, thread 185 may engage lid 118, as will be described further below.

Turning now specifically to FIG. 12, in some example embodiments, rim 180 may include a first magnet 186 and a second magnet 188. In general, first magnet 186 and second magnet 188 may be spaced apart around rim 180 in the circumferential direction C. For example, first magnet 186 and second magnet 188 may be spaced approximately seventy degrees (70°) apart around rim 180 of ring 116. In particular, first magnet 186 may generally be positioned at the first position of ice bucket 114 and second magnet 188 may be positioned at the second position of ice bucket 114. As stated above, rim 164 of ice bucket 114 may include a magnet 166 configured to securely position ice bucket 114 in each the first position and the second position. For example, magnet 166 within rim 164 of ice bucket 114 may engage with first magnet 186 of ring 116 in the first position and magnet 166 of ice bucket 114 may engage with second magnet 188 of ring 116 in the second position, thus securing ice bucket 114 in each the first position and the second position. As an example, magnet 166 of ice bucket 114 may be placed approximately halfway along slot 160 (e.g., as shown in FIG. 6), and first magnet 186 and second magnet 188 may be placed such that tab 142 engages one of the ends (not labeled) of slot 160 when ice bucket 114 is in the first position and/or the second position, as described above.

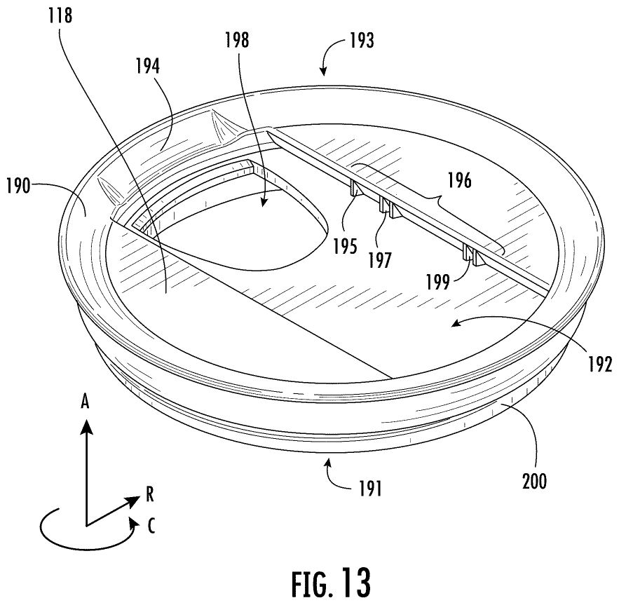

Turning now to FIG. 13, provided is a perspective view of lid 118. In general, lid 118 may extend, in the axial direction A, between a bottom side 191 and a top side 193. In general, lid 118 may removably couple to ring 116. In particular, lid 118 may include a thread 200 extending from bottom side 191 of lid 118. As stated above, thread 185 of ring 116 may engage lid 118, e.g., thread 185 of ring 116 may engage thread 200 of lid 118. Additionally or alternatively, lid 118 may directly couple to cup 102 (e.g., without filter bucket 112, ice bucket 114, and ring 116) via thread 200 of lid 118 engaging thread 105 of cup 102.

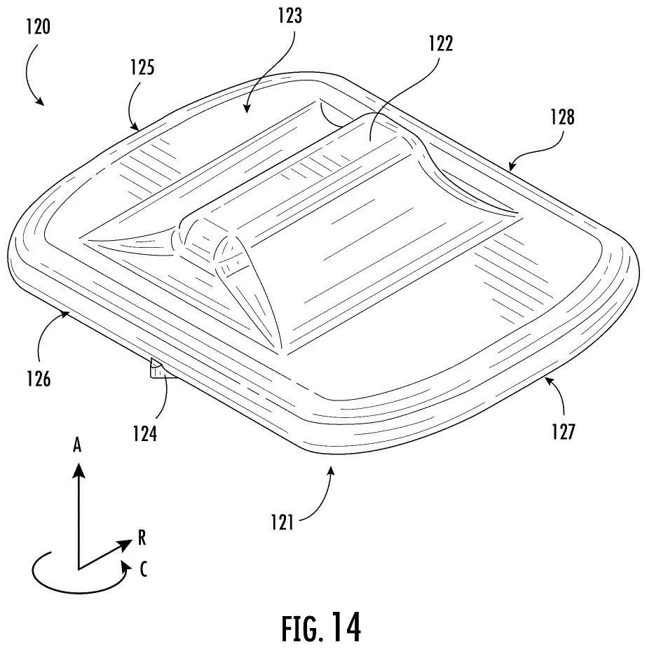

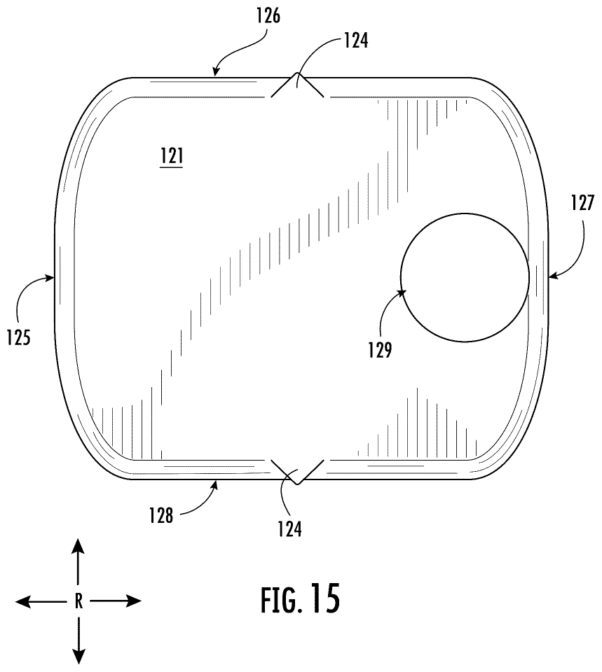

In general, lid 118 may include a rim 190 spanning around the circumferential direction C. In general, rim 190 may include a spout 194 positioned approximately adjacent (with respect to the radial direction R) to an opening 198 in lid 118. In general, opening 198 of lid 118 may be positioned within a slot 192 within lid 118, and opening 198 may be sized to dispense liquid as well as ice from within snack cup assembly 100, e.g., opening 198 may span an area of approximately two and a half square centimeters (2.5 cm²). One of skill in the art would understand the size of opening 198 is provided by way of example only and is not intended to be limiting to the subject matter of the present embodiment. In general, slot 192 may extend downwards in the axial direction A, such as toward bottom side 191 of lid 118, and slot 192 may extend across a length (not labeled) of lid 118 in the radial direction R, such as toward spout 194. Looking now at FIGS. 14 and 15, provided are various views of slider 120.

In particular, FIG. 14 provides a perspective view of slider 120 and FIG. 15 provides a bottom view of slider 120. In general, slider 120 may extend, in the axial direction A, between a bottom side 121 and a top side 123, and may extend, in the radial direction R, between a front side 125, a back side 127, a first side 126 and a second side 128. Slider 120 may generally include a grip 122 extending upwards in the axial direction A from top side 123 of slider 120. In general, slider 120 may be received within slot 192 of lid 118, e.g., bottom side 121 of slider 120 may engage within slot 192 of lid 118 (FIG. 2).

Seen best in FIG. 15, slider 120 may generally include a protrusion 124 extending, in the radial direction R, from first side 126. In particular, slider 120 may include a pair of protrusions 124, one protrusion 124 extending from first side 126 and the other protrusion 124 extending from second side 128. Protrusion 124 will be described further below. In some example embodiments, slider 120 may include a hole 129. Hole 129 may generally be configured to receive a straw (not shown). As such, hole 129 of slider 120 may align in the axial direction A with opening 198 of lid 118, hole 169 of ice bucket 114, and/or holes 149 of filter bucket 112, such that a straw (not shown) may extend through lid assembly 110 into cup 102.

Turning back to FIG. 13, slot 192 of lid 118 may define a plurality of detents 196 within slot 192. In particular, the plurality of detents 196 may include a first detent 195, a second detent 197 (e.g., as shown, second detent 197 may be a pair of detents), and a third detent 199 (e.g., as shown, third detent 199 may be a pair of detents). Referring generally to FIGS. 13 through 15, protrusion 124 of slider 120 may engage the plurality of detents 196 within slot 192 of lid 118. In particular, protrusion 124 may engage first detent 195 while slider 120 is in a first position (FIG. 1) within slot 192 of lid 118. In particular, the first position of slider 120 may block, or cover, opening 198 of lid 118, such that contents within cup 102 and/or lid assembly 110 may be prevented/restricted from exiting opening 198. Protrusion 124 may engage second detent 197 while slider 120 is in a second position (not shown) within slot 192 of lid 118. In general, the second position of slider 120 may expose at least some of opening 198 of lid 118, such that liquid may exit through opening 198, but larger contents, such as ice within ice bucket 114 may be prevented/restricted from exiting opening 198. Further, protrusion 124 may engage third detent 199 while slider 120 is in a third position (not shown) within slot 192 of lid 118. In general, the third position may expose all of opening 198 of lid 118, such that liquid and/or ice from ice bucket 114 may exit through opening 198.

Referring generally to FIGS. 1 through 15, lid assembly 110 may be operable to selectively dispense contents within snack cup assembly 100. In particular, while ice bucket 114 is in the first position (FIG. 8) and slider 120 is in the second position, snack cup assembly 100 may dispense liquid contents from within cup 102, e.g., such as a beverage of choice of a user, e.g., water, soda (pop), etc. Additionally, while ice bucket 114 is in the first position (FIG. 8) and slider 120 is in the third position, snack cup assembly 100 may dispense liquid contents from within cup 102 and ice from within ice bucket 114. Additionally or alternatively, a user may rotate ice bucket 114 to the second position (FIG. 9), where liquid from within cup 102 is prevented from flowing through opening 168 in ice bucket 114. As such, while ice bucket 114 is in the second position and slider 120 is in the third position, snack cup assembly 100 may dispense ice from ice bucket 114, such as without liquid. As such, with the various positions of snack cup assembly 100, a user may pour liquid, pour liquid and ice, or just pour ice from snack cup assembly 100.

As may be seen from the above, a beverage container may include a separate compartment for ice, such as nugget ice. The container may include a slider on top of a lid that may move between three positions. When the slider on the lid is fully closed (first position), the container may be sealed. When the lid is slightly open (e.g., the slider is in the second position), the slider may block ice pieces, e.g., ice nuggets, from exiting, but water (or other liquid, e.g., a beverage) may exit the lid, and when the lid is all the way open (e.g., the slider is in the third position), ice, e.g., nugget ice, may also exit the lid along with the liquid. Further, the ice compartment of the lid assembly may include two mechanically fixed positions that rotate to seal an opening in the lid assembly. The first position exposes the opening allowing liquid to flow into the ice compartment, and the second position seals and prevents the liquid from entering the ice compartment.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A snack cup assembly defining an axial direction, a radial direction, and a circumferential direction, the snack cup assembly comprising:
a cup defining an interior volume; and
a lid assembly removably coupled to the cup, the lid assembly comprising:
a filter bucket removably coupled within the interior volume of the cup;
an ice bucket positioned atop the filter bucket in the axial direction, the ice bucket comprising a rim defining a slot;
a ring positioned atop the rim of the ice bucket in the axial direction, the ring coupled to the filter bucket through the slot in the ice bucket;
a lid removably coupled to the ring, the lid defining a slot and an opening within the slot; and
a slider slidably positioned within the slot of the lid,
wherein the ice bucket is rotatable between a first position and a second position within the lid assembly.

2. The snack cup assembly of claim 1, wherein the filter bucket comprises a floor defining an opening, and wherein the ice bucket comprises a floor defining an opening.

3. The snack cup assembly of claim 2, wherein the first position of the ice bucket comprises the opening of the filter bucket aligning, in the axial direction, with the opening of the ice bucket.

4. The snack cup assembly of claim 2, wherein the second position of the ice bucket comprises the opening of the filter bucket offset, in the circumferential direction, from the opening of the ice bucket.

5. The snack cup assembly of claim 2, wherein the opening defined in the floor of the filter bucket comprises a sealing ring sealingly engaging the floor of the ice bucket in the second position.

6. The snack cup assembly of claim 1, wherein the ring comprises a rim comprising a first magnet and a second magnet, the first magnet positioned at the first position of the ice bucket, the second magnet positioned at the second position of the ice bucket, and wherein the rim of the ice bucket comprises a magnet configured to engage with the first magnet of the ring in the first position and the second magnet of the ring in the second position.

7. The snack cup assembly of claim 1, wherein the cup defines a thread at a top side of the cup, and wherein the filter bucket comprises a rim defining a thread, the thread of the filter bucket engages the thread of the cup.

8. The snack cup assembly of claim 1, wherein the filter bucket comprises a rim comprising a tab extending in the axial direction through the slot in the ice bucket, and wherein the ring is coupled to the tab of the filter bucket through the slot in the ice bucket, whereby the ice bucket is rotatable in the circumferential direction between the filter bucket and the ring.

9. The snack cup assembly of claim 1, wherein the slider comprises a protrusion extending from a side of the slider.

10. The snack cup assembly of claim 9, wherein the lid defines a plurality of detents within the slot, where the protrusion of the slider engages the plurality of detents within the slot of the lid.

11. A snack cup assembly defining an axial direction, a radial direction, and a circumferential direction, the snack cup assembly comprising:
a cup defining an interior volume; and
a lid assembly removably coupled to the cup, the lid assembly comprising:
a filter bucket removably coupled within the interior volume of the cup;
an ice bucket positioned atop the filter bucket in the axial direction, the ice bucket comprising a rim defining a slot;
a ring positioned atop the rim of the ice bucket in the axial direction, the ring coupled to the filter bucket through the slot in the ice bucket; and
a lid removably coupled to the ring, the lid defining a slot and an opening within the slot,
wherein the ice bucket is rotatable between a first position and a second position within the lid assembly.

12. The snack cup assembly of claim 11, wherein the filter bucket comprises a floor defining an opening, and wherein the ice bucket comprises a floor defining an opening.

13. The snack cup assembly of claim 12, wherein the first position of the ice bucket comprises the opening of the filter bucket aligning, in the axial direction, with the opening of the ice bucket.

14. The snack cup assembly of claim 12, wherein the second position of the ice bucket comprises the opening of the filter bucket offset, in the circumferential direction, from the opening of the ice bucket.

15. The snack cup assembly of claim 12, wherein the opening defined in the floor of the filter bucket comprises a sealing ring sealingly engages the floor of the ice bucket in the second position.

16. The snack cup assembly of claim 11, wherein the ring comprises a rim comprising a first magnet and a second magnet, the first magnet positioned at the first position of the ice bucket, the second magnet positioned at the second position of the ice bucket, and wherein the rim of the ice bucket comprises a magnet configured to engage with the first magnet of the ring in the first position and the second magnet of the ring in the second position.

17. The snack cup assembly of claim 11, wherein the cup defines a thread at a top side of the cup, and wherein the filter bucket comprises a rim defining a thread, the thread of the filter bucket engages the thread of the cup.

18. The snack cup assembly of claim 11, wherein the filter bucket comprises a rim comprising a tab extending in the axial direction through the slot in the ice bucket, and wherein the ring is coupled to the tab of the filter bucket through the slot in the ice bucket, whereby the ice bucket is rotatable in the circumferential direction between the filter bucket and the ring.

19. The snack cup assembly of claim 11, further comprising a slider slidably positioned within the slot of the lid, the slider comprises a protrusion extending from a side of the slider.

20. The snack cup assembly of claim 19, wherein the lid defines a plurality of detents within the slot, where the protrusion of the slider engages the plurality of detents within the slot of the lid.
